(19) United States
(12) Patent Application Publication
(10) Pub. No.: US 2013/0206332 A1
(43) Pub. Date: Aug. 15, 2013

(54) ADHESIVE TAPE, ADHESION DEVICE AND ADHESION METHOD

(71) Applicants: Wen Chang Jiang, Wujiang (CN); Wei Huang, Wujiang (CN); Ching-Feng Hsieh, Taipei (TW)

(72) Inventors: Wen Chang Jiang, Wujiang (CN); Wei Huang, Wujiang (CN); Ching-Feng Hsieh, Taipei (TW)

(73) Assignees: ASKEY COMPUTER CORPORATION, New Taipei City (TW); ASKEY TECHNOLOGY ( JIANGSU) LTD., Wuijiang (CN)

(21) Appl. No.: 13/482,591

(22) Filed: May 29, 2012

(30) Foreign Application Priority Data
Feb. 10, 2012 (TW) 101104319

(51) Int. Cl. B32B 33/00; B32B 38/10; B32B 37/00

(52) U.S. Cl. 156/249; 428/41.8; 156/538

(57) ABSTRACT

An adhesive tape is disclosed. The adhesive tape includes a first release layer, an adhesive layer, and a second release layer, wherein the second release layer has a positioning portion, and a total area of the second release layer is greater than a total area of the first release layer. Further, an adhesion device and an adhesion method are disclosed. The adhesion device includes a base having a receiving slot and a positioning unit. The adhesive tape is received in the receiving slot of the base, such that the positioning portion of the adhesive tape and the positioning unit of the base are used for positioning each other. After the first release layer is removed to expose the adhesive layer, a supporting component is adhered to the adhesive layer.

### BACKGROUND OF THE INVENTION

1. Field of Invention

The present invention relates to adhesive tapes and adhesion methods employing the same, and, more particularly, to an adhesive tape for a touch panel of an electronic device, an adhesion device for the adhesive tape, and an adhesion method.

2. Background of the Invention

Currently, a touch panel is manually adhered to a casing of an electronic device via a tape, wherein the attachment is performed by aligning, attaching, pressing and tearing. As shown in FIGS. 1A and 1B, in the conventional adhesion process, one side of an adhesive tape is attached to a casing 100 of an electronic device, a release paper on the other side of the adhesive tape 110 is peeled off to expose an adhesive layer 111, and then a touch panel 200 is adhered to the adhesive layer 111 on the casing 100 of the electronic device. This adhesion procedure process is time-consuming and has inconveniences. For example, while the adhesive tape 110 is adhered to the casing 100 of the electronic device, (1) it is hard to position the adhesive tape 110; (2) the adhesive tape 110 is a narrow strip, and is thus not easily aligned; and (3) the adhesive tape 110 is so narrow that the release paper is not easily peeled off. In the prior art, there is no positioning mechanism for an adhesive tape, such that the position of the adhesive tape is often misaligned. Moreover, the adhesive tape is so narrow that the release paper is not easily peeled off and the adhesion is inconvenient. Further, the manual adhesion makes unstable quality of the product, such that the cost is high and the yield of the product is significantly affected.

Accordingly, there is a need to provide an adhesive tape for overcoming the conventional drawbacks.

### SUMMARY OF THE INVENTION

The present invention provides an adhesive tape to facilitate an adhesion process.

The present invention further provides an adhesion device and an adhesion method to standardize the adhesion process.

The adhesive tape of the present invention includes a first release layer, an adhesive layer coupled to the first release layer, and a second release layer adhered to the adhesive layer such that the adhesive layer is interposed between the first release layer and the second layer, and being formed with at least a positioning portion and having a total area greater than a total area of the first release layer.

In an embodiment of the present invention, the first release layer and the adhesive layer may be respectively a hollow frame, a strip or L-shaped.

In an embodiment of the present invention, the positioning portion may be a positioning hole or a positioning protrusion.

The present invention further provides an adhesion device for facilitating an adhesive tape having a positioning portion to be adhered to a supporting component. The adhesion device includes a base having a receiving slot and a positioning unit, wherein the receiving slot is used for receiving the adhesive tape, the positioning unit of the adhesive tape and the positioning unit are used for positioning each other, and the supporting component is placed on the adhesive tape, such that the supporting component is adhered to the adhesive tape.

In an embodiment of the present invention, the positioning unit is a positioning pillar or a positioning slot.

In an embodiment of the present invention, the adhesion device further includes a pressing component. The pressing component is configured to move toward the base for providing a vertical force to securely adhering the supporting component to the adhesive tape.

In addition, the present invention provides an adhesion method applicable to a base having a positioning unit. The adhesion method includes the steps of providing an adhesive tape formed of a stack of a first release layer, an adhesive layer and a second release layer in sequence, wherein the second release layer has at least a positioning portion, and a total area of the second release layer is greater than a total area of the first release layer; disposing the adhesive tape on the base, wherein the positioning portion of the adhesive tape is corresponding in position to the positioning unit of the base; and removing the first release layer to expose the adhesive layer, such that a supporting component is allowed to be adhered to the adhesive layer.

In accordance with the adhesive tape, the adhesion device and the adhesion method of the present invention, the second release layer of the adhesive layer has a positioning portion to perform positioning, the adhesive tape is adhered to the supporting component via the adhesion device, then a touch panel is adhered to the supporting component, and the adhesive tape is adhered to a casing of an electronic device, such that the adhesion process of a touch panel is completed. In comparison with the prior art, the second release layer of the present invention has a greater area such that the conventional drawbacks resulting from the narrow adhesive tape is overcome, and is formed with a positioning portion for performing positioning. Hence, the present invention may save time, save labor, improve quality of adhesion and increase the yield of products.

### BRIEF DESCRIPTION OF THE DRAWINGS

FIGS. 1A and 1B are schematic views showing an adhesion method according to the prior art;

FIG. 2 is a schematic view showing an adhesive tape according to an embodiment of the present invention;

FIG. 3 is a schematic view showing an adhesive tape according to another embodiment of the present invention;

FIGS. 4A to 4D are schematic views showing adhesive tapes according to various embodiment of the present invention;

FIG. 5 is a schematic view showing an adhesion device according to an embodiment of the present invention;

FIGS. 6A to 6F are schematic views showing a touch panel to be adhered to a casing of an electronic device according to an embodiment of the present invention; and

FIG. 7 is a schematic view showing a pressing device for pressing and adhering a touch panel to a supporting component according to an embodiment of the present invention.

### DETAILED DESCRIPTION OF THE PREFERRED EMBODIMENTS

The following specific examples are used for illustrating the present invention. A person skilled in the art can easily conceive the other advantages and effects of the present invention.

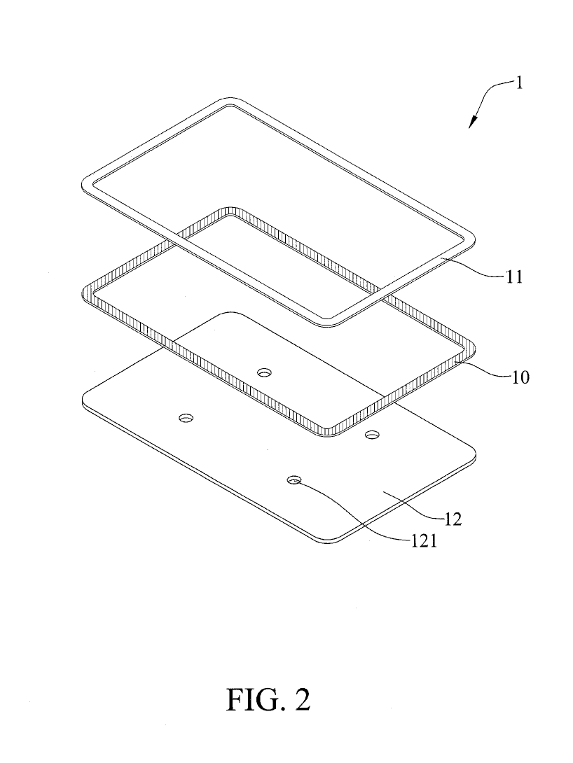

FIG. 2 shows a schematic view of an adhesive tape according to the present invention. The adhesive tape provides the adhesion between a touch panel and an electronic device. As shown in FIG. 2, the adhesive tape 1 includes an adhesive layer 10, a first release layer 11, and a second release layer 12.

The adhesive tape 1 is formed of a stack of a first release layer 11, an adhesive layer 10 and a second release layer 12. The adhesive layer 10 is interposed between to the first release layer 11 and the second release layer 12. The area and the shape of the first release layer 11 may be similar to those of the adhesive layer 10. The second release layer 12 has a positioning portion, and the total area of the second release layer 12 is greater than the total area of the first release layer 11. Further, in order to facilitate the positioning and operation of the adhesive tape 1, the second release layer 12 is formed with at lease a positioning portion. In an embodiment, the positioning portion may be four positioning holes 121 for aligning with other components.

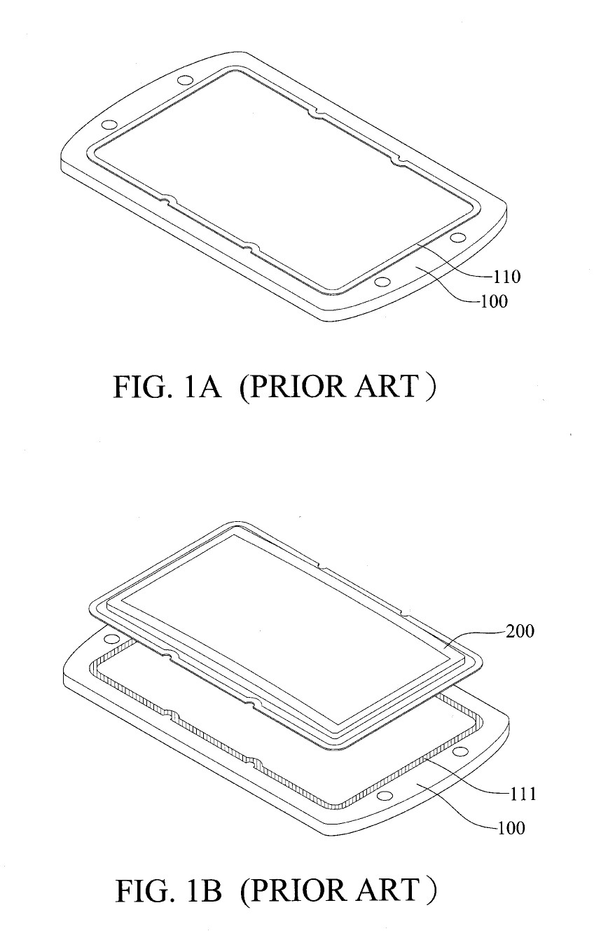

In the prior art, the release paper on the adhesive tape has the same size as the adhesive tape, and the release paper on the adhesive tape 110 (FIG. 1A) is peeled off to expose the adhesive layer 111 (FIG. 1B), which has the same size as the release paper, and thus causes difficulty on peeling off and adhering. In an embodiment of the present invention, the second release layer 12 is greater in area than the first release layer 11 and has positioning holes, such that after having peeled off the first release layer 11 and the second release layer 12, the adhesive tape 1 is easily adhered to other components such as a supporting component.

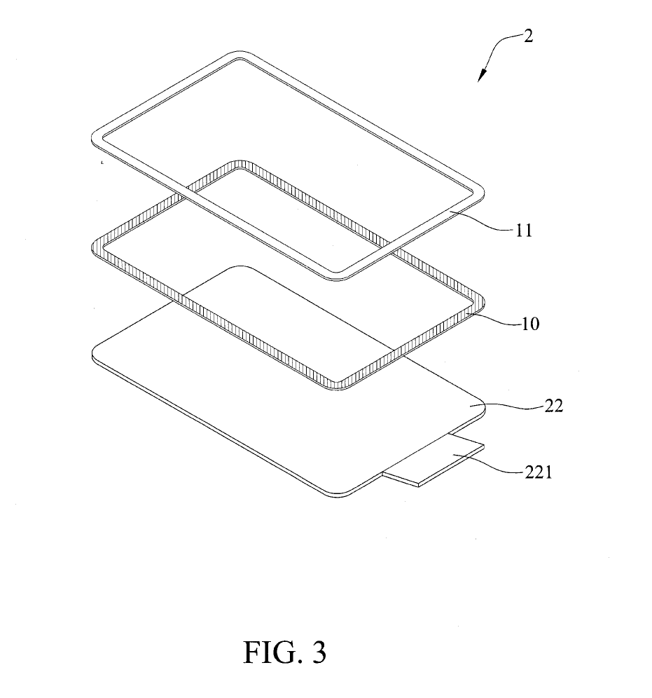

FIG. 3 shows an adhesive tape according to another embodiment of the present invention. As shown in FIG. 3, the adhesive tape 2 provides the adhesion between a touch panel and a casing of an electronic device, wherein the adhesive layer 10 and the first release layer 11 on the adhesive tape 1 are the same as those shown in FIG. 2 except that the positioning portion is a positioning protrusion 221 in the embodiment. In other words, the positioning protrusion 221 protruded from the second release layer 22 to match with a corresponding design such as a receiving slot for the alignment.

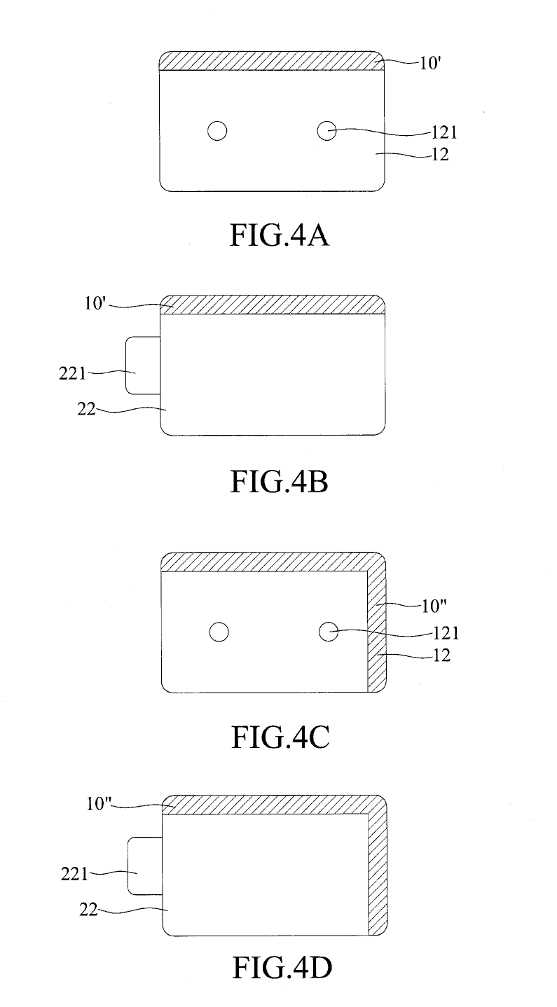

In the above embodiments of the present invention, the adhesive layer 10 has a structure of a thin frame. The shape of the adhesive layer 10 may be a hollow frame, a strip or an L-shape. The hollow frame may be that shown in FIGS. 2 and 3. Further, the shape of the first release layer 11 may be a hollow frame, a strip or an L-shape. The positioning portion may be a positioning hole or a positioning protrusion, and the adhesive tape may have various shapes, so as to form various combinations. FIGS. 4A to 4D show various adhesive tapes according to embodiments of the present invention.

In FIG. 4A, the adhesive layer 10′ has a structure of a strip, and the second release layer 12 has positioning holes 121. In FIG. 4B, the adhesive layer 10′ has a structure of a strip, and the second release layer 22 has a positioning protrusion 221. In FIG. 4C, the adhesive layer 10″ is L-shaped, and the second release layer 22 has a positioning protrusion 221. Accordingly, there is no limitation to the shape of the adhesive tape and the shape of the positioning portion.

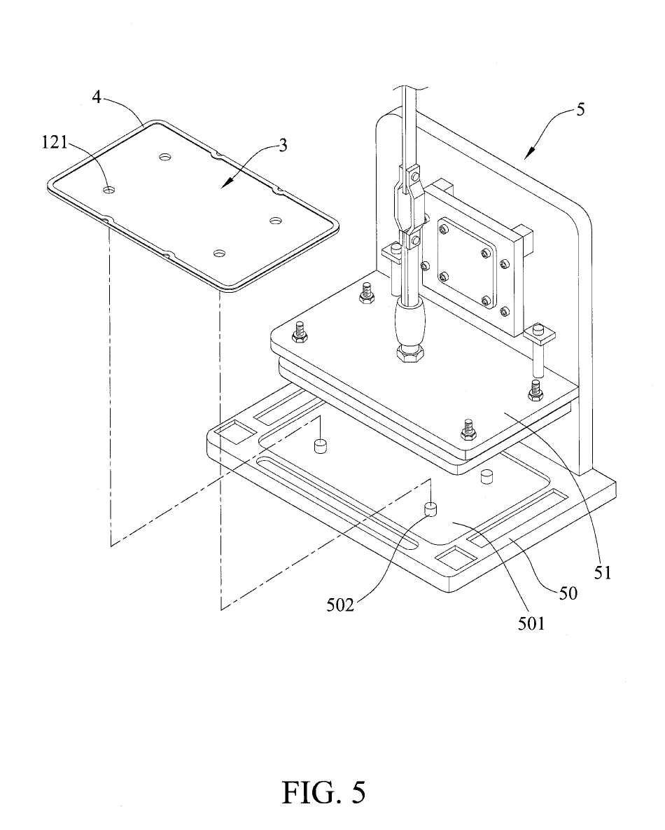

FIG. 5 shows an adhesion device according to the present invention. The adhesion device 5 provides a pressing force after the adhesive tape 3 is adhered to the supporting component 3 shown in FIG. 2. The adhesion device 5 includes a base 50 and a pressing component 51.

A receiving slot 501 and a positioning unit 502 are formed on a surface of the base 50 for receiving and positioning the adhesive tape 3. The supporting component 4 is adhered on the adhesive tape 3. The base 50 is disposed at the lower portion of the adhesion device 5, and has a receiving slot 501 for receiving the adhesive tape 3. The adhesive tape 3 is positioned by the positioning unit 502. In other words, in FIG. 2, the positioning holes 121 on the second release layer 12 of the adhesive tape 1 are formed in corresponding to the positioning unit 502, so as to provide a function of positioning. The first release layer of the adhesive tape 3 is peeled off to expose the adhesive layer, to thereby allow the supporting component 4 to be adhered on the adhesive tape 3. The supporting component 4 provides a supporting force to the adhesive tape 3. It is difficult to operate the conventional adhesive tape since the adhesive tape has no hardness, the adhesive tape thus is not easily aligned and adhered, and the release layer disposed on the adhesive tape is not easily peeled off. In contrast, the supporting component 4 according to the present invention provides a support to facilitate the operation and the adhesion of other components. In addition, the positioning unit 502 may be a positioning pillar or a positioning slot.

The pressing component 51 on the base 50 is configured to move toward the base 50 and thus provides a vertical force to press the supporting component 4 to be adhered on the adhesive tape 3. In other words, the pressing component 51 applies a vertical downward force to securely adhere the supporting component 4 to the adhesive tape 3, so as to form a tight adhesion structure of the adhesive tape 3 and the supporting component 4. It is to be noticed that only essential components are described in the embodiment to illustrate the operation of the adhesion device 5 while being used for pressing to render secure adhesion, and other components are omitted to be illustrated.

The adhesive tape shown in FIG. 2 and the adhesion device shown in FIG. 5 are combined to illustrate the adhesion between a touch panel and a casing of an electronic device. The adhesion among the touch panel, the supporting component and the casing of the electronic device are formed via the adhesive tape, so as to adhere the touch panel to the casing of the electronic device.

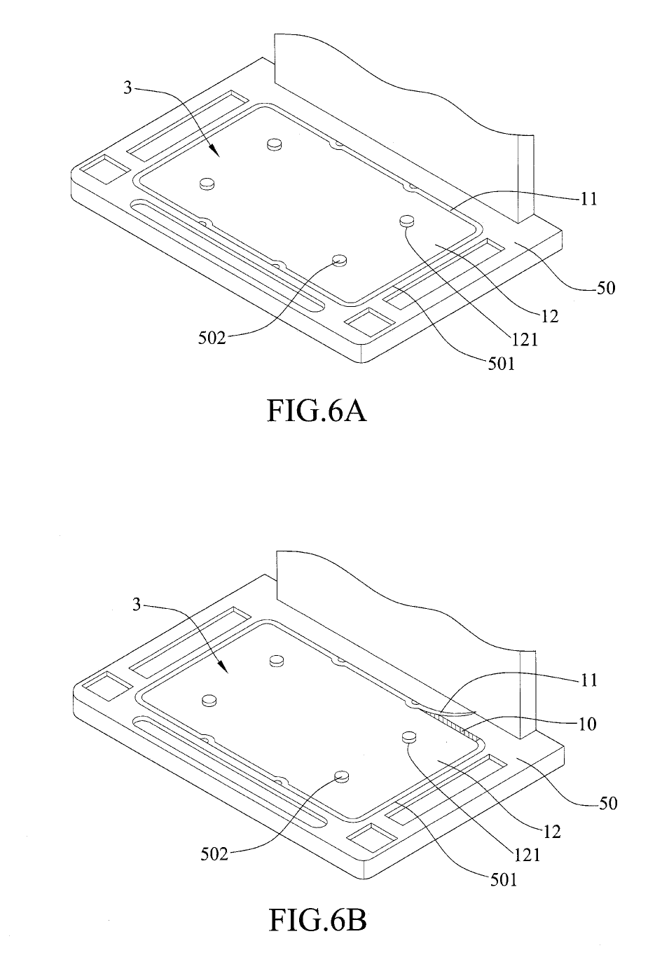

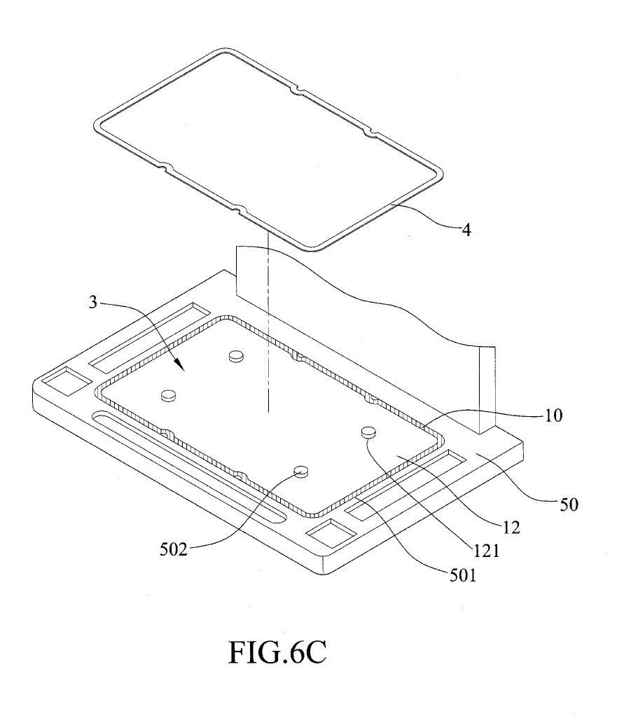

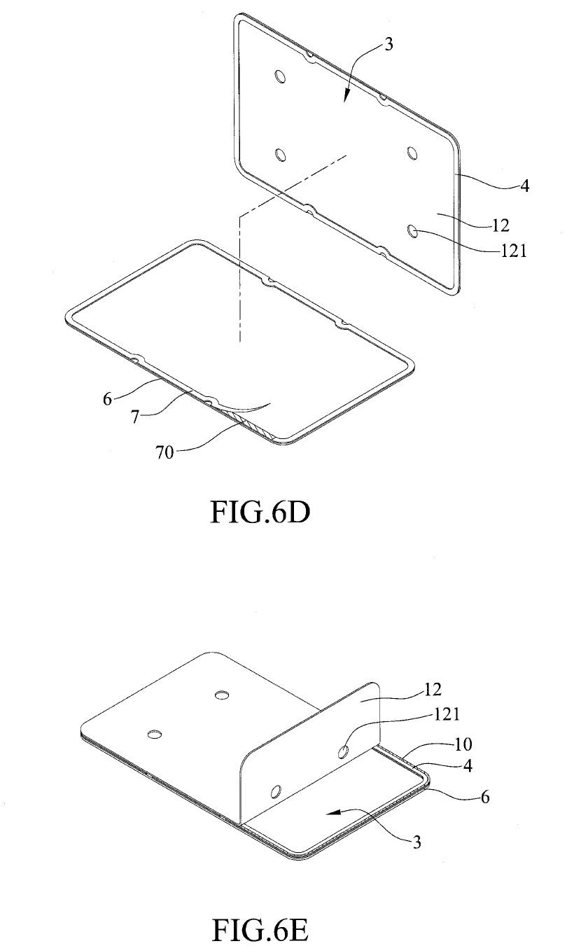

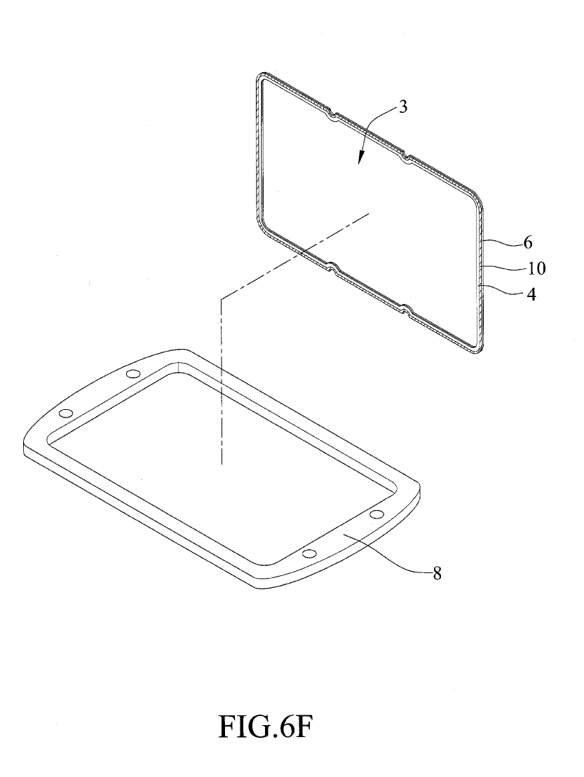

FIGS. 6A to 6F illustrate the method for adhering a touch panel to a casing of an electronic device in accordance with the present invention.

Referring to FIG. 6A, an adhesive tape 3 is secured in a receiving slot 501 of a base 50 of an adhesion device shown in FIG. 5. A first release layer 11 is disposed at the rim of the adhesive tape 3, an adhesive layer is covered under the first release layer 11 (which does not expose), and there are four positioning holes 121 on a second release layer 12 of the adhesive tape 3 to be corresponding in position to the positioning unit 502 of the base 50 for positioning.

Referring to FIG. 6B, the first release layer 11 of the adhesive tape 3 is removed to expose the adhesive layer 10. As shown in FIG. 6A, the adhesive layer is covered under the first release layer 11, such that the adhesive layer 10 of the adhesive tape 3 is exposed after peeling off the first release layer 11.

Referring to FIG. 6C, the supporting component 4 is corresponding to the adhesive layer 10, and adhered to the adhesive layer 10. Specifically, after the first release layer 11 is peeled off, the supporting component 4 is adhered to the adhesive layer 10, and the supporting component 4 is pressed to be securely adhered to the adhesive tape 3 via the adhesion device shown in FIG. 5. The supporting component 4 may provide a supporting force to support the adhesive tape 3, so as to facilitate the connection of the touch panel, the supporting component and the casing of the electronic device.

As shown in FIGS. 6A to 6C, the adhesive tape 3 is positioned via the positioning holes 121 and the positioning unit 502, so as to avoid misalignment during the adhesion owing to the narrow adhesive tape, as in the prior art. Further, after the second release layer 12 is positioned, the first release layer 11 is easily peeled off as shown in FIG. 6B. The adhesive tape 3 is allowed to be precisely adhered to the supporting component 4 via the positioning holes 121 and the positioning unit 502.

Referring to FIG. 6D, a release paper 7 of the touch panel 6 is removed to expose an attaching layer 70, and the supporting component 4 adhered to the adhesive tape 3 has a surface to be correspondingly adhered to the exposed attaching layer 70 of the touch panel 6. The touch panel 6 with the attaching layer 70 is thus provided. The release paper 7 on the attaching layer 70 is peeled off to expose the attaching layer 70, and then the supporting component 4 adhered to the adhesive tape 3 shown in FIG. 6C is adhered to the attaching layer 70. One surface of the supporting component 4 has been previously adhered to the adhesive layer of the adhesive tape 3, and the other surface of the supporting component 4 is adhered to the attaching layer 70 of the touch panel 6 shown in FIG. 6D, so as to achieve the adhesion between the touch panel 6 and the supporting component 4.

Referring to FIG. 6E, the second release layer 12 of the adhesive tape 3 is removed to expose the other surface of the adhesive layer 10. More specifically, the second release layer 12 is peeled off to expose the adhesive layer 10, wherein one surface of the adhesive layer 10 has been previously adhered to the supporting component 4, and the supporting component 4 is also adhered to the touch panel 6 in FIG. 6D.

Referring to FIG. 6F, a casing 8 of an electronic device is correspondingly adhered to the adhesive layer 10. In other words, the structure (having an exposing surface of the adhesive layer 10) obtained in FIG. 6E is correspondingly adhered to the casing 8 of the electronic device, such that the adhesion between the touch panel 6 and the casing 8 of the electronic device is achieved.

In comparison with the prior art (such as FIGS. 1A and 1B), the adhesion method of the present invention shown in FIGS. 6A to 6F has a greater area of a release paper (such as the second release layer 12 in FIG. 2), so as to provide more convenient adhesion, facilitate alignment of adhesion, reduce misalignment of adhesion and thus improve the yield of adhesion.

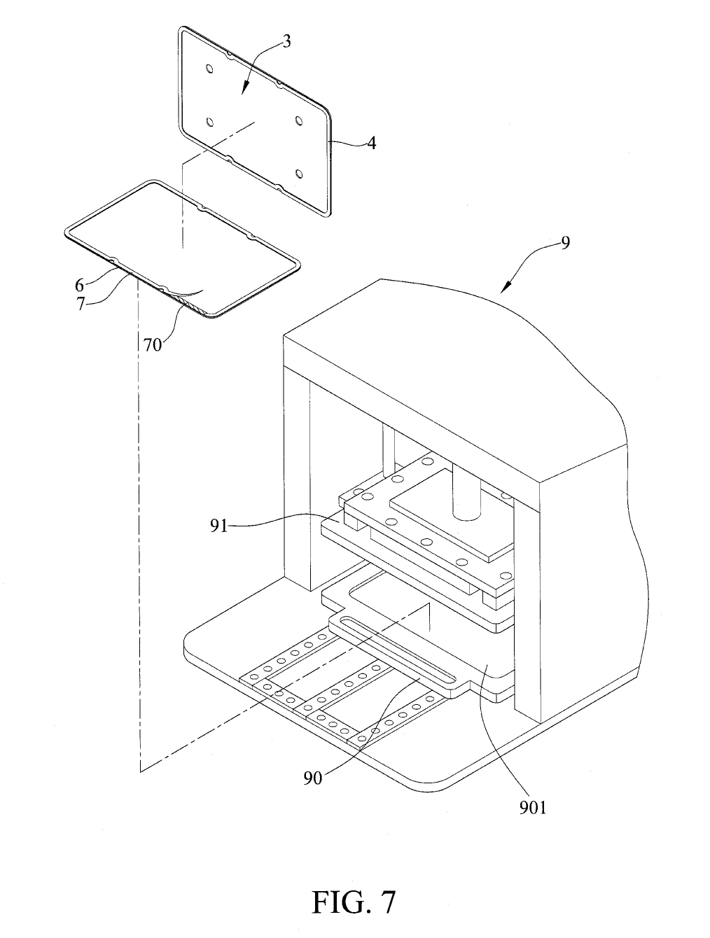

FIG. 7 is a schematic view showing a pressing device for pressing and adhering a supporting component to a touch panel. A pressing device 9 is used for securely adhere the supporting component 4 to the adhesive tape 3 shown in FIG. 6D and a touch panel 6. The pressing device 9 includes a base 90 and a pressing component 91. The touch panel 6 is secured in a receiving portion 901 of the base 90, a release paper 7 on the touch panel 6 is peeled off to expose an attaching layer 70, the supporting component 4 adhered to the adhesive tape 3 is aligned with and placed on the touch panel 6, and then a downward pressing force is applied by the pressing component 91 to press the supporting component 4 to the touch panel 6, such that the supporting component 4 is securely adhered to the touch panel 6.

Accordingly, in accordance with the adhesive tape, the adhesion device and the adhesion method of the present invention, the release paper on the adhesive tape is large and the positioning portion is provided so as to facilitate the adhesion adjustment between the adhesive tape and the supporting component, an adhesion device having a pressing component is provided for securely adhering the adhesive layer of the adhesive tape to the supporting component, then a touch panel is adhered to a surface of the supporting component, and the adhesive layer of the adhesive tape is adhered to a casing of an electronic device, such that the touch panel is securely adhered to the casing of the electronic device. Further, the adhesive tape of the present invention has a release paper with a large area for facilitating the operation of the adhesive tape, and the positioning portion on the release paper provides alignment during the adhesion process. In comparison with the prior art, the present invention improves quality of adhesion and yield of products.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

What is claimed is:

1. An adhesive tape, comprising:
a first release layer;
an adhesive layer coupled to the first release layer; and
a second release layer coupled to the adhesive layer such that the adhesive layer is interposed between the first release layer and the second release layer, the second release layer having a positioning portion and a total area greater than a total area of the first release layer.

2. The adhesive tape of claim 1, wherein the positioning portion is a positioning hole or a positioning protrusion.

3. The adhesive tape of claim 1, wherein the first release layer and the adhesive layer are respectively a hollow frame, a strip or L-shaped.

4. An adhesion device for facilitating an adhesive tape that has a positioning portion to be adhered to a supporting component, the adhesion device comprising:
a base having a receiving slot configured to receive the adhesive tape; and
a positioning unit,
wherein the positioning portion of the adhesive tape and the positioning unit are used for positioning the supporting component on the adhesive tape, thereby adhering the supporting component to the adhesive tape.

5. The adhesion device of claim 4, wherein the positioning unit is a positioning pillar or a positioning protrusion.

6. The adhesion device of claim 4, further comprising a pressing component that moves toward the base for providing a vertical force to support securely adhere the supporting component to the adhesive tape.

7. An adhesion method for a positioning unit of a base, comprising:
providing an adhesive tape formed of a stack of a first release layer, an adhesive layer and a second release layer in sequence, wherein the second release layer has a positioning portion, and a total area of the second release layer is greater than a total area of the first release layer;
disposing the adhesive tape on the base, wherein the positioning portion of the adhesive tape is corresponding in position to the positioning unit of the base; and
adhering a supporting component to the adhesive layer after removing the first release layer to expose the adhesive layer.

8. The adhesion method of claim 7, wherein the supporting component is coupled to a casing of an electronic device for providing a supporting force.

9. The adhesion method of claim 7, further comprising providing a vertical force to make securely adhere the supporting component to the adhesive tape.
